(19) United States
(12) Patent Application Publication
(10) Pub. No.: US 2012/0330608 A1
(43) Pub. Date: Dec. 27, 2012

(54) STEP COUNTING SYSTEM AND STEP COUNTER

(75) Inventor: PENG WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/205,635

(22) Filed: Aug. 9, 2011

(30) Foreign Application Priority Data
Jun. 27, 2011 (CN) 201110174779.5

(51) Int. Cl. G01C 22/00

(52) U.S. Cl. 702/160

(57) ABSTRACT

A step counting system includes a portable terminal and a step counter. The portable terminal includes a processor and a first communication interface. The step counter includes a motion sensor, a step detector, a controller, and a second communication interface. The second communication interface communicates with the first communication interface. The motion sensor senses motion of a user carrying the step counter. The detector detects whether a step motion is sensed by the motion sensor. The controller transmits an increment by one signal to the processor each time a step is detected by the detector. The processor updates its display of the number of steps by increasing the number of steps by one each time the processor receives the increment by one signal from the controller.

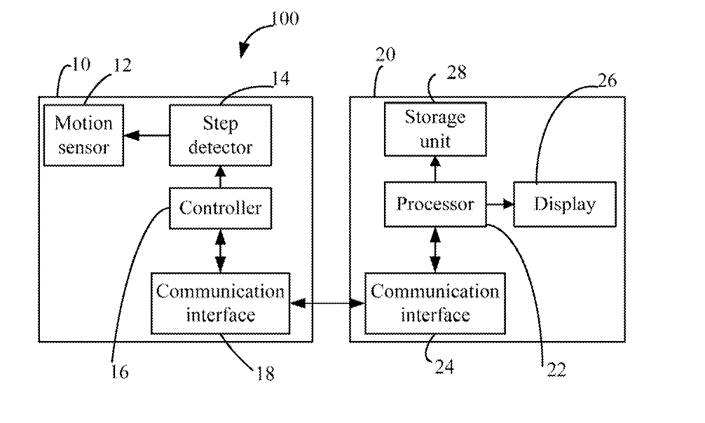

### BACKGROUND

1. Technical Field

The present disclosure relates to step counting systems and step counters.

2. Description of Related Art

Step counters, commonly called pedometers, may be clipped to a user at his/her waist, and it can be troublesome to view them on the go.

### BRIEF DESCRIPTION OF THE DRAWINGS

The components of the drawing are not necessarily drawn to scale, the emphasis instead being placed upon clearly illustrating the principles of a step counting system and a step counter.

The drawing is a block diagram of a step counting system in accordance with an exemplary embodiment.

### DETAILED DESCRIPTION

Referring to the drawing, a step counting system 100 includes a step counter 10 and a portable terminal 20 communicating with the step counter 10. The portable terminal 20 may be a mobile phone, a PDA, or the like. In use, the step counter 10 may be clipped to a user's waist, and the portable terminal 20 may be held by a user or even strapped to a wrist or hung about the neck of the user. The step counter 10 transmits an increment by one signal to the portable terminal 20 each time a step is sensed. The portable terminal 20 updates the number of steps shown on its display 26 by increasing the number of steps by one each time the portable terminal 20 receives the increment by one signal from the step counter 10. With such configuration, the user can learn the number of steps he/she takes in real time by viewing the display 26, rather than viewing a display (not shown) of the step counter 10. While walking or running, using the portable terminal 20 to look up the number of steps the user takes does not affect accuracy of the step counter 10, and the display 26 can be relatively large, thus it is very convenient for the user.

The step counter 10 includes a motion sensor 12, a step detector 14, a controller 16, and a communication interface 18. The portable terminal 20 includes a processor 22, a communication interface 24, the display 26, and a storage unit 28. The step counter 10 communicates with the portable terminal 20 through the communication interface 18 and the communication interface 24. The communication interface 18 and the communication interface 24 may be wired or wireless communication interfaces. The motion sensor 12 senses motion of a user carrying the step counter 10. The step detector 14 detects whether a step motion is sensed by the motion sensor 12. The controller 16 transmits the increment by one signal to the processor 22 each time a step motion is detected by the step detector 14. The processor 22 updates the number of steps shown on the display 26 by increasing the number of steps by one each time the processor 22 receives the increment by one signal from the controller 16.

The storage unit 28 stores a step length. If the processor 22 does not receive the increment by one signal from the controller 16 within a preset period, the processor 22 determines that the user has stopped walking or running, and multiplies the number of steps currently displayed on the display 26 by the step length to obtain a walking or running distance. The processor 22 further displays the determined distance on the display 26. Options and reset commands may be entered using an interface of the portable terminal 20.

In this embodiment, the processor 22 further transmits on/off commands to the controller 16 in response to user input to direct the controller 16 to turn on/off the step counter 10.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A step counting system comprising:
a portable terminal comprising a processor, a display, and a first communication interface; and
a step counter comprising a motion sensor, a step detector, a controller, and a second communication interface, the second communication interface to communicate with the first communication interface, the motion sensor to sense motion of a user carrying the step counter, the step detector to detect whether a step motion is sensed by the motion sensor, the controller to transmit an increment by one signal to the processor via the first and second communication interfaces each time a step motion is detected by the step detector;
the processor to update the number of steps shown on the display by increasing the number of steps by one each time the processor receives the increment by one signal from the controller.

2. The step counting system as described in claim 1, wherein the portable terminal further comprises a storage to store a step length, the processor is further to multiply the number of steps currently displayed on the display by the step length to obtain a distance if the processor does not receive the increment by one signal from the step counter within a preset period.

3. The step counting system as described in claim 1, wherein the processor is further to transmit on/off commands to the controller to direct the controller to turn on/turn off the step counter.

4. The step counting system as described in claim 1, wherein the first communication interface and the second communication interface are wired or wireless interfaces.

5. A step counter comprising:
a motion sensor to sense motion of a user carrying the step counter;
a step detector to detect whether a step motion is sensed by the motion sensor;
a communication interface to communicate the step counter with a portable terminal; and
a controller to transmit an increment by one signal to the portable terminal each time a step motion is detected by the step detector.

6. The step counter as described in claim 5, wherein the controller is further to turn on/turn off the step counter when receiving on/off commands from the portable terminal

7. The step counter as described in claim 5, wherein the communication interface is wired or wireless interface.
